(19) United States
(12) Patent Application Publication
(10) Pub. No.: US 2017/0286383 A1
(43) Pub. Date: Oct. 5, 2017

(54) AUGMENTED IMAGING ASSISTANCE FOR VISUAL IMPAIRMENT

(71) Applicant: Microsoft Technology Licensing, LLC, Redmond, WA (US)

(72) Inventors: Anirudh Koul, San Jose, CA (US); Ao Li, Burnaby (CA); Elias Haroun, Montreal (CA); Irene Wen Ling Chen, Vancouver (CA); Shweta Sharma, Mississauga (CA); Christiano Bianchet, Montreal (CA); Saqib Shaikh, London (GB); Stéphane Morichère-Matte, Vancouver (CA); Biing Tsyr Lai, Ottawa (CA); Nathan Pak Kei Lam, Burnaby (CA); Wendy Lu, Delta (CA)

(21) Appl. No.: 15/242,940

(22) Filed: Aug. 22, 2016

Related U.S. Application Data
(60) Provisional application No. 62/315,081, filed on Mar. 30, 2016.

(51) Int. Cl. G06F 17/24; G06T 11/60; G06K 9/46; G06F 3/16

(52) U.S. Cl. CPC G06F 17/241; G06F 3/167; G06T 11/60; G06K 9/4671; G06K 2209/01

(57) ABSTRACT

Systems, apparatuses, services, platforms, and methods are discussed herein that provide assistance for user interface devices. In one example, an assistance application is provided comprising an imaging system configured to capture an image of a scene, an interface system configured to provide data associated with the image to a distributed assistance service that responsively processes the data to recognize properties of the scene and establish feedback for a user based at least on the properties of the scene, and a user interface configured to provide the feedback to the user.

### RELATED APPLICATIONS

This application hereby claims the benefit of and priority to U.S. Provisional Patent Application 62/315,081, titled “AUGMENTED IMAGING ASSISTANCE FOR VISUAL IMPAIRMENT,” filed Mar. 30, 2016, which is hereby incorporated by reference in its entirety.

### BACKGROUND

Personal user devices, such as smartphones, can allow users to run a variety of applications, such as those configured to capture images, play games, or engage in productivity activities, among other applications. These applications and associated graphical user interfaces can be challenging to use for those with various physical impairments, such as visual impairments. Recently, intelligent personal assistants have been included on the user devices to allow a user to interact with the user devices using voice commands in addition to traditional touchscreens, buttons, or keypads. However, interacting with real-world objects and elements can still be difficult, and many of the applications are unable to fully serve those with visual or other impairments.

### OVERVIEW

Systems, apparatuses, services, platforms, and methods are discussed herein that provide assistance for user interface devices. In one example, an assistance application is provided comprising an imaging system configured to capture an image of a scene, an interface system configured to provide data associated with the image to an assistance service that responsively processes the data to recognize properties of the scene and establish feedback for a user based at least on the properties of the scene, and a user interface configured to provide the feedback to the user.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 is a system diagram of a user assistance system in an implementation.

FIGS. 2A, 2B, and 2C illustrate example methods of operating a user assistance system.

FIG. 3 illustrates an example computing platform for implementing any of the architectures, processes, methods, and operational scenarios disclosed herein.

FIG. 4 illustrates two example annotated scenes.

FIG. 5 illustrates an example annotated scene.

FIG. 6 illustrates example operation of a user assistance application in an implementation.

FIG. 7 illustrates an example user assistance interface in an implementation.

### DETAILED DESCRIPTION

User interfaces provided by many user devices, such as smartphones, tablet computers, gaming systems, and the like, can be challenging to use for those with various physical impairments, such as visual impairments. Intelligent personal assistants, such as Microsoft Cortana® have been included on the user devices to allow a user to interact with the user devices using voice commands in addition to traditional touchscreens, buttons, or keypads. However, interacting with real-world objects and elements can still be difficult, and many of the applications are unable to fully serve those with visual or other impairments.

Discussed herein are various applications, devices, services, and interfaces that provide assistance to a user of a personal communication device. This assistance can include augmented reality-based assistance, such as scene recognition, scene description, document recognition, and photo assistance, among other examples. In typical examples, a user will employ a computing device to receive input from the real world, such as via a digital camera and microphone. This input can be processed using various services which interpret scenes captured by a camera or interpret elements in the scene according to questions or queries by a user. Further examples include interpreting documents in pictures taken by a user, or recognizing menus, signs, and objects. Scene recognition can be employed to determine elements or objects in an image and intelligently interpret the elements to relay appropriate information to the user.

“Seeing” artificial intelligence (AI) can be employed in some examples to establish computer vision-based assistance. Seeing AI can comprise a user application or service that helps users who are visually impaired to understand who and what is around them. Seeing AI can be employed in smartphone/tablet applications, discrete devices like smart glasses, augmented reality visors, or other devices. Seeing AI can aurally guide users in taking photographs of documents, people, or other objects/elements in a scene. Seeing AI can describe scenes in natural language sentences and can answer questions posed by users regarding photographs taken by the users.

The various examples discussed herein include different example of computer-vision based recognition of items of interest in a scene that is captured by a user. In a first operational scenario, an image or photograph is interpreted for a user. In this scenario, a user or device initiates capture of an image, such as using a digital camera portion of a user device. The image is processed by one or more services which recognize various elements in the image and associate scene captured by the image. These services comprise intelligent vision-based services, among others, and generate structured information about the image. A user can ask questions about the image and the structured information that is presented to the user. These questions can prompt further image processing for further structured information or can prompt services to further interpret the image. For example, a user can capture an image of a person on a sofa. This image can be processed by one or more recognition services to determine information about the scene captured in the image. In response, the services can provide information such as “the image includes a person sitting on a sofa reading a book.” Which can prompt follow up questions from the user, such as “what book is the person reading” “what color is his shirt” or “describe the person,” among other questions. The services can further process the image and the questions to determine answers such as “the person is a man about age 24, wearing a blue shirt, smiling, and reading War and Peace.”

Further examples and scenarios include object recognition (i.e. identifying objects and where are they located in an image or scene), scene description services (i.e. generating plain language descriptions based on objects recognized in an image or scene). Images can include text or other written symbols and various recognition can be performed on those images, including optical character recognition (OCR) (i.e. identifying text, character locations), document structure identification (such as identifying headings/fonts/structure of text). Other symbols can be recognized and identified, such as product recognition (identifying logos/brands), and bar code or QR-code recognition and querying (identifying bar codes and obtaining associated data). Intelligent human recognition and detection, such as face detection, gender detection, age estimation, and emotion recognition. Document boundary identification (i.e. edge detection, image centering) can also be applied to images to assist in centering or positioning documents or other elements within a frame of an image. Color detection and reporting to a user can be performed for various elements of a scene. Speech to text processing can be performed for videos or audio content, and text to speech processing can be performed for textual items found in images or scenes. Intent classifier processing can also be included to determine intent of user queries. For example, this intent classification can include classifying verbal queries such as a user asking “what's written here” to prompt an OCR process be performed on text found in an image or scene.

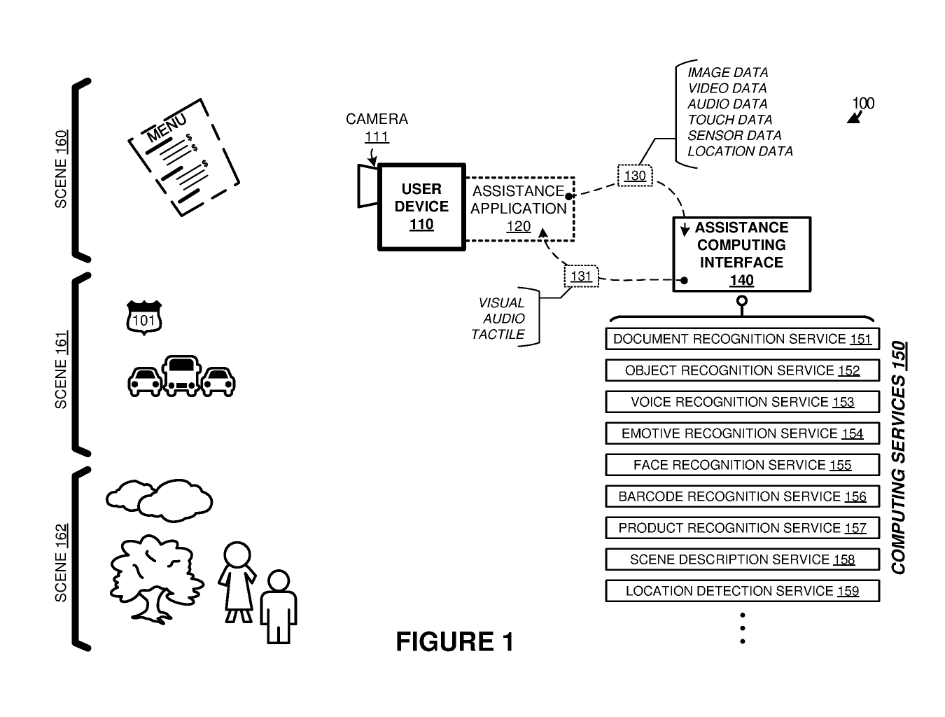

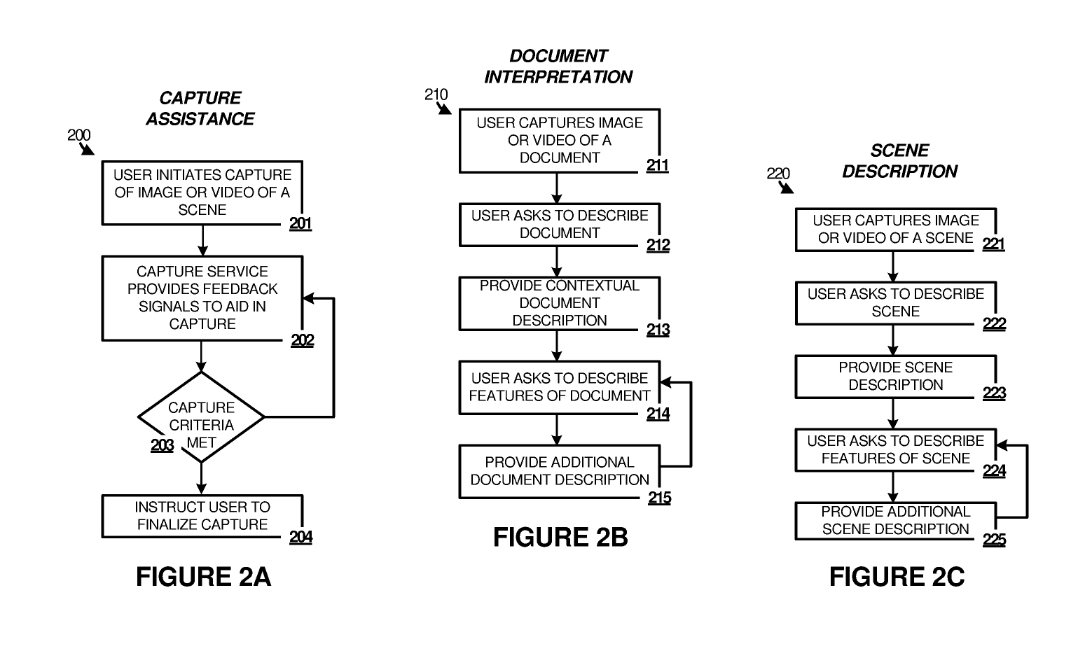

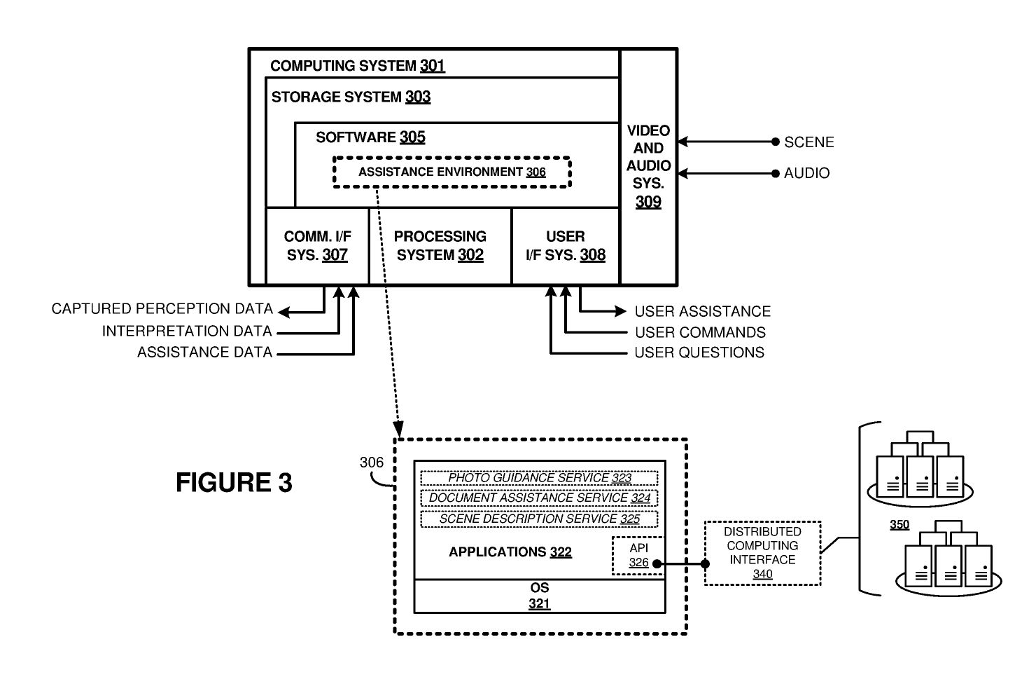

Several operational examples are now presented as related to systems, services, and apparatuses that can be employed to perform and of the examples or operational scenarios herein. FIG. 1 is a system diagram of user assistance system 100. FIGS. 2A, 2B, and 2C each detail various example methods of operation of the elements of FIG. 1. FIG. 3 illustrates an example computing platform for implementing any of the architectures, processes, methods, and operational scenarios disclosed herein.

Turning first to FIG. 1, system 100 includes user device 110, assistance computing interface 140, and computing services 150. User device 110 includes camera 111 and assistance application 120. Several example scenes are included in FIG. 1 to illustrate various operation scenarios that can be assisted by the elements of system 100. A first scene 160 comprises a document or menu, a second scene 161 comprises traffic/roadway elements, and a third scene 162 comprises an outdoor scene. These will be discussed in further detail in FIGS. 2A, 2B, and 2C.

User device 110 can be a smartphone, tablet computer, laptop, personal communication device, personal assistance device, wireless communication device, subscriber equipment, customer equipment, access terminal, telephone, mobile wireless telephone, personal digital assistant, personal computer, e-book, mobile Internet appliance, wireless network interface card, media player, game console, gaming system, or some other communication apparatus, including combinations thereof. Elements of user device 110 include imaging equipment, such as camera 111, transceiver circuitry, processing circuitry, and user interface elements. The transceiver circuitry typically includes amplifiers, antennas, filters, modulators, and signal processing circuitry. User device 110 can also include user interface systems, network interface card equipment, memory devices, non-transitory computer-readable storage mediums, software, processing circuitry, or some other communication components. In some examples, user device 110 includes elements of assistance computing interface 140 or computing services 150.

User device 110 and assistance computing interface 140 can communicate over one or more communication links. In some examples, user device 110 communicates with assistance computing interface 140 over one or more network links, such as over wireless or wired network links. Other configurations are possible with elements of user device 110, assistance computing interface 140, and computing services 150 coupled over various logical, physical, or application programming interfaces. Example communication links can use metal, glass, optical, air, space, or some other material as the transport media. Example communication links can use various communication protocols, such as Time Division Multiplex (TDM), Internet Protocol (IP), Ethernet, synchronous optical networking (SONET), asynchronous transfer mode (ATM), hybrid fiber-coax (HFC), circuit-switched, communication signaling, wireless communications, or some other communication format, including combinations, improvements, or variations thereof. Communication links can be direct links or may include intermediate networks, systems, or devices, and can include a logical network link transported over multiple physical links.

Assistance computing interface 140 can include communication interfaces, network interfaces, processing systems, computer systems, microprocessors, storage systems, storage media, or some other processing devices or software systems, and can be distributed among multiple devices or across multiple geographic locations. Examples of assistance computing interface 140 can include software such as an operating system, logs, databases, utilities, drivers, networking software, and other software stored on a computer-readable medium. Assistance computing interface 140 can comprise one or more platforms which are hosted by a distributed computing system or cloud-computing service. Assistance computing interface 140 can comprise logical interface elements, such as software defined interfaces and Application Programming Interfaces (APIs).

Computing services 150 can comprise one or more services which are hosted by a distributed computing system or cloud-computing service. In FIG. 1, computing services 150 include document recognition service 151, object recognition service 152, voice recognition service 153, emotive recognition service 154, face recognition service 155, barcode recognition service 156, product recognition service 157, scene description service 158, and location detection service 159. Other services and recognition platforms can be provided, and the ones discussed in FIG. 1 are merely exemplary.

Document recognition service 151 can provide optical character recognition services for documents, food menus, road signs, object labels, whiteboards, or other objects which contain readable text and symbols. Object recognition service 152 can provide intelligent recognition of objects and elements in a scene imaged by a user, such as vehicles, people, various physical objects, surface features, fabrics, colors, brightness, among other intelligent recognition of objects, elements, and associated properties. Voice recognition service 153 can process voice commands or audio signals to recognize instructions issued by a user or to identify properties of audio signals. Emotive recognition service 154 can provide recognition of human emotive states based on image data and audio data, such as to identify emotional expressions, facial expressions, hand movements, or other emotive characteristics of people. Face recognition service 155 can provide identification of people based on facial properties of captured images, such as to identify names, genders, and conditions of people using facial recognition techniques. Barcode recognition service 156 can work in conjunction with document recognition service 151 to identify content encoded in barcodes, QR codes, or other visually encoded information. Product recognition service 157 provides recognition of commercial, industrial, or artistic products using object labelling, logo identification, optical character recognition, barcode recognition, or other techniques. Scene description service 158 can provide recognition of objects and elements within a scene, such as identification of a setting, positioning and action of objects in a scene, and establish descriptive language useful to describe a scene to a user. Location detection service 159 can provide location determination services, such as via global positioning services (GPS), trilateration, triangulation, scene recognition and placement, among other techniques.

Each of the example computing services discussed in FIG. 1 can be employed separately or in combination. These computing services can be provided to users via assistance computing interface 140 which can synthesize and distribute input and output data between a user and the associated computing services. Assistance computing interface 140 or assistance application 120 can form one or more specialized services from among the computing services offered. These specialized services can synthesize output data or output instructions using one or more of computing services 150. For example, a document reading service can be provided to a user that interacts via voice commands This document reading service can comprise document recognition service 151, object recognition service 152, voice recognition service 153, barcode recognition service 156, among other services. Assistance computing interface 140 or assistance application 120 can provide data to each of the selected services and receive resultant data from the selected services which is synthesized or combined into a document reading service for the user. Other services can be provided using combinations of the computing services.

In one example operation of FIG. 1, a user can capture an image (or video) using camera 111 on user device 110. This image capture can be initiated within assistance application 120 or other user applications executed on user device 110. Once an image or images have been captured, the image data and other related information or data can be transferred by user device 110 to provide the user with one or more assistance features, such as visual assistance features.

For example, FIG. 1 shows data 130 transferred for delivery to assistance computing interface 140. Data 130 can include image data, video data, audio data, touch sensor data, sensor data, or location data, among other data and information. The audio data can be captured by a microphone of user device 110. Touch sensor data can be captured from a touch screen of user device 110 or a touch sensor, such as a fingerprint sensor or other sensor. Further sensor data can include image or screen brightness data, acceleration data, wireless signal strength data, available link bandwidth data, or other sensor data monitored by user device 110. This further sensor data can be used by computing services 150 to further qualify or analyze the image or video data provided by user device 110. Location data can include positioning data of user device 110, such as determined by GPS, or other location identification processes.

User device 110 can also provide one or more commands or instructions in data 130 which requests various processing and recognition services provided through assistance computing interface 140. Assistance computing interface 140 can then parse the commands or instructions along with the provided data to select and distribute further commands/instructions and data to one or more of computing services 150. Computing services 150 that are employed by assistance computing interface 140 can then process the associated data and instructions to provide one or more output results which are then transferred for delivery to user device 110. These output results can comprise visual, audio, or tactile outputs, as indicated by data 131 in FIG. 1.

To provide further operational examples of the elements of FIG. 1, FIGS. 2A, 2B, and 2C are provided. The operations described in FIGS. 2A, 2B, and 2C can also describe operations of any of the devices or systems discussed herein, such as found in FIG. 3. In each of the examples, assistance application 120 of user device 110 provides image data, scene data, video data, query information, or other data and information to assistance computing interface 140. The image can be a single image, series of images, video, or other media including image data. The image data can be viewed by a user on a display or other graphical user interface of user device 110. The graphical user interface can include image capture interfaces, live preview interfaces, or can be captured via peripheral devices such as glasses-mounted imaging devices, remote imaging devices, or other imaging elements which may or may not provide the image data for preview to a user before processing by computing services 150.

Assistance computing interface 140 can select among one or more of computing services 150 to process the data and information provided by user device 110 to establish the associated recognition or description services 141-159. In some examples, assistance computing interface 140, along with computing services 150, are distributed over more than one computing system or platform, such as found in ‘cloud’ computing or virtualized computing service platforms. Assistance computing interface 140 intelligently selects among the various computing services to provide the data or information associated with a user request/query, and these selected computing services process the data or information to provide the various corresponding processing, detection, and recognition services to the user. Iterative and repetitive user queries on image or scene elements can proceed, so that a user can continue to receive further details, descriptions, or recognition provided in response to further queries. Moreover, various search queries, such as Internet searches, social media searches, or web searches, can be performed on the elements recognized in the scenes or based on textual information recognized in scenes, among other elements. These search queries can be prompted by the user or can be automatically performed upon recognition of the various elements in the scene.

Turning first to FIG. 2A, assistance is provided to a user to capture an image. This assistance can include directing a user to move a camera or associated user device in a three-dimensional space to bring objects of interest into focus, into frame, into proper orientation, or to ensure desired features of an object of interest are able to be captured in an image. The assistance can include directional prompts or alerts which direct a user to move an imaging device to better capture an image or element of interest in a scene. Directional notifications can prompt the user to move an imaging sensor of the imaging system of user device 110 (such as camera 111) to increase a recognition level of at least one element in the scene. The alerts can include audio, visual, tactile, or other alerts which can prompt directional positioning as well as capture initiation prompts to a user, such as prompting an alert indicating that the image is positioned and ready for capture.

First, a user initiates capture of image or video of a scene (201) in assistance application 120. User device 110 can capture an image or video using camera 111 or other imaging equipment. The image or video can be captured of one or more object in a scene, such as any of scenes 160-162, among others. However, the user might request assistance from user device 110 in properly including the objects of interest in the frame of the image. The user might not have the objects in focus, in frame, or might not satisfy other criteria for image capture. For example, in scene 160, a user might desire to capture an image of a menu so the menu can be read aloud to the user. Object recognition service 152 might be employed to detect edges or boundaries of an object and an image capture service that employs object recognition service 152 provides feedback signals to aid in capture (202). The edges or boundaries of the object can be compared to boundaries of the image and instructions can be synthesized for the user to move camera 111 to include the object fully in the frame. Other criteria can be employed to ensure an object is properly in frame, such as employing facial recognition to ensure the desired people are in the frame, or scene description to ensure background objects are properly positioned, or other criteria.

The desired criteria can be established automatically or according to user instructions. For example, the user might instruct, via text or voice commands, that the user desires certain people to be in the frame of the image, or that a certain menu or document be included in the image. Automatic criteria can be established when few objects are in a scene, or when the user selects a particular capture mode, such as a document capture mode will automatically use any documents in frame to aid in centering/framing. Other criteria can be established both by the user and associated software/services.

Once the desired criteria are met (203) then application 120 can instruct the user to finalize capture of the image (204). The instructions can comprise an audio instruction to the user. The audio instructions can include audio tones that change as a user brings objects of interest into frame and indicate when a desired object is properly positioned. The audio instructions can include spoken word instructions that direct the user to act accordingly, such as movement instructions. The instructions can also include haptic or vibration feedback to indicate to the user that objects are properly positioned. In some examples, the image can be automatically captured when a user has properly positioned camera 111 or properly positioned objects within a frame.

A second example operation is discussed in FIG. 2B. FIG. 2B comprises a process for a user to receive document interpretation services. In the operations of FIG. 2B, a user can interact with user device 110 and assistance application 120 using voice commands, audible descriptions, text commands or descriptions, or other interaction paradigms.

In FIG. 2B, a user captures an image or video of a document (211), such as by using techniques discussed in FIG. 2A. A user first asks to describe a document (212). This document can be captured in an image by the user using camera 111 or could be a document captured previously, among other documents/images. Assistance application 120 can provide the document of interest to assistance computing interface 140 which can employ one or more of the computing services, such as document recognition service 151. Contextual or high-level document descriptions can be provided to the user (213). A hierarchical description of the document can be established, and an initial description provided to the user can include contextual descriptions might include a description of the type of document, a listing of the headings or sections of a document, or other descriptions that are higher in a hierarchical description. The user can responsively ask questions or queries (214) about particular portions of the initial description, such as asking for a listing of entrees under an entrée section of a food menu. The user can iterate through questions and answers with document recognition service 151 to establish the information or description details desired by the user (215).

As a further example of document assistance, a user first asks to describe a document captured in an image or ‘live’ in a continually updating image capture process. Assistance application 120 indicates a document recognition request with data associated with the image to assistance computing interface 140. Assistance computing interface 140 responsively employs computing services 150 to recognize one or more textual formatting properties of a document captured in the image. Assistance application 120 receives document description information determined based at least on the one or more textual formatting properties of a document captured in the image. User device 110 presents the document description information to the user. Based on the document description information, a user can perform at least one search query using descriptors in the document description information to retrieve further descriptors for the document, and user device 110 can present the further descriptors to the user. For example, information returned to the user for a first query can be used by the user to issue further queries which can be refined with each query iteration.

In another example operation of the elements of FIG. 1, FIG. 2C is presented. FIG. 2C provides scene description to a user. Similar to the document description operations of FIG. 2B, the scene description operations of FIG. 2C can include one or more computing services, such as object recognition service 152 and scene description service 158, among others. In the operations of FIG. 2C, a user can interact with user device 110 and assistance application 120 using voice commands, audible descriptions, text commands or descriptions, or other interaction paradigms.

In FIG. 2B, a user captures an image or video of a scene (221), such as by using techniques discussed in FIG. 2A. A user first asks to describe a scene (222). This scene can be captured in an image by the user using camera 111 or could be a scene captured previously, among other scenes/images. Assistance application 120 can provide the scene of interest to assistance computing interface 140 which can employ one or more of the computing services, such as object recognition service 152 and scene description service 158. Contextual or high-level scene descriptions can be provided to the user (223). At least partial recognition information can be determined for the scene. A hierarchical description of the scene can be established, and an initial description provided to the user can include contextual descriptions might include a description of the setting, surroundings, large objects, number of people, or other descriptions that are higher in a hierarchical description. The user can responsively ask questions or queries (224) about particular portions of the initial scene description, such as asking for further description of the people in the scene or a further description of the actions being performed in a video of a scene. The user can iterate through questions and answers to establish the scene information or scene description details desired by the user (225).

Annotations can be established for the scene, with graphical overlays or annotations merged onto a graphical user interface that captures the scene. For example, a live video or preview interface can be presented to the user that captures the scene and corresponds to the image data or scene data provided to assistance computing interface 140. assistance computing interface 140 can employ computing services 150 to determine annotation information which can be presented to the user in the live video or preview interface. This annotation information can be overlaid onto the images presented on user device 110 for inspection and viewing by the user.

In the examples herein, such as those discussed in FIGS. 2A, 2B, and 2C, assistance application 120 can provide assistance and descriptions to the user on various fronts. Assistance application 120 can process image data, along with any contextual sensor or other data, to understand elements or objects in the image data as well as synthesize answers to user questions related to the images. Structured information can be determined from one or more images taken by the user using computer vision algorithms provided by computing services 150. Structured metadata can be established for the data, and can include locations of artifacts or elements in the images. For example, performing optical character recognition on an image can provide metadata for the image that includes text recognized in the image. The text can be arranged according to which object in the image that the text is associated with, such as when many objects include text in an image. Object recognition can provide descriptions of the objects themselves as well as relationships between objects in the image (distances, depth relationships, relative sizes, and the like). Barcode recognition can provide metadata comprising product names, prices, or other barcode properties.

A tree structure or hierarchy can be established for the metadata and arranged according to the particular objects or elements recognized in an image or video. Each top-level node of the tree or hierarchy can represent a particular object or element, while lower-level nodes for each object/element can include further descriptive metadata for those objects/elements. Parent-child object relationships can be established, and physical or logical relationships can span across many objects and nodes to properly represent real-world or metadata connections between objects/elements.

In a particular example, an image might be captured of a woman in a red shirt reading a book. A possible graph-based data structure can include (with example (x, y) coordinates):
Photo
   Object=“Person”
      Gender=“Female”
      Image Region=(x1,y1,x2,y2)
      Face
         Emotion=“Neutral”
         Age=“24”
         Image Region=(x3,y3,x4,y4)
   Object=“Shirt”
      Color=“Red”
      Image Region=(x5,y5,x6,y6)
   Object=“Book”
      Region=(x7,y7,x8,y8)
      Text=“Harry Potter”
         Image Region=(x9,y9,x10,y10).

In spoken-word examples, users can speak in natural language to assistance application 120 which can provide speech-to-text transcriptions of the user interactions, such as a spoken question. The question can be processed by a classifier process to understand the intent of the question and the entity of interest. Alternatively, the text of the question can be processed by a question answering pipeline to understand the entity of interest and the information requested. The question text can also be processed through a dependency parser to extract the object and required information needed. For example, a question comprising “what is the color of the shirt” can be parsed as follows: object shirt, information needed=color, proximity relation=of (contained). A question about a bus can comprise “what is the number on the bus” and the parsing can comprise: object bus, information needed=text (numeric), proximity relation=on (contained). Follow up questions, such as for the bus example, can include “what is the number next to the bus” with parsing comprising: object bus, information needed=text (numeric), proximity relation=next (near). Thus, using the graph based information structure above, these questions can be answered by traversing the structure from the root node till the object of interest is found, based on a proximity relation, search inside or around for information which is suitable for the proximity relationship, and ranking based on a hybrid score (e.g. distance from the main object for a proximity relationship).

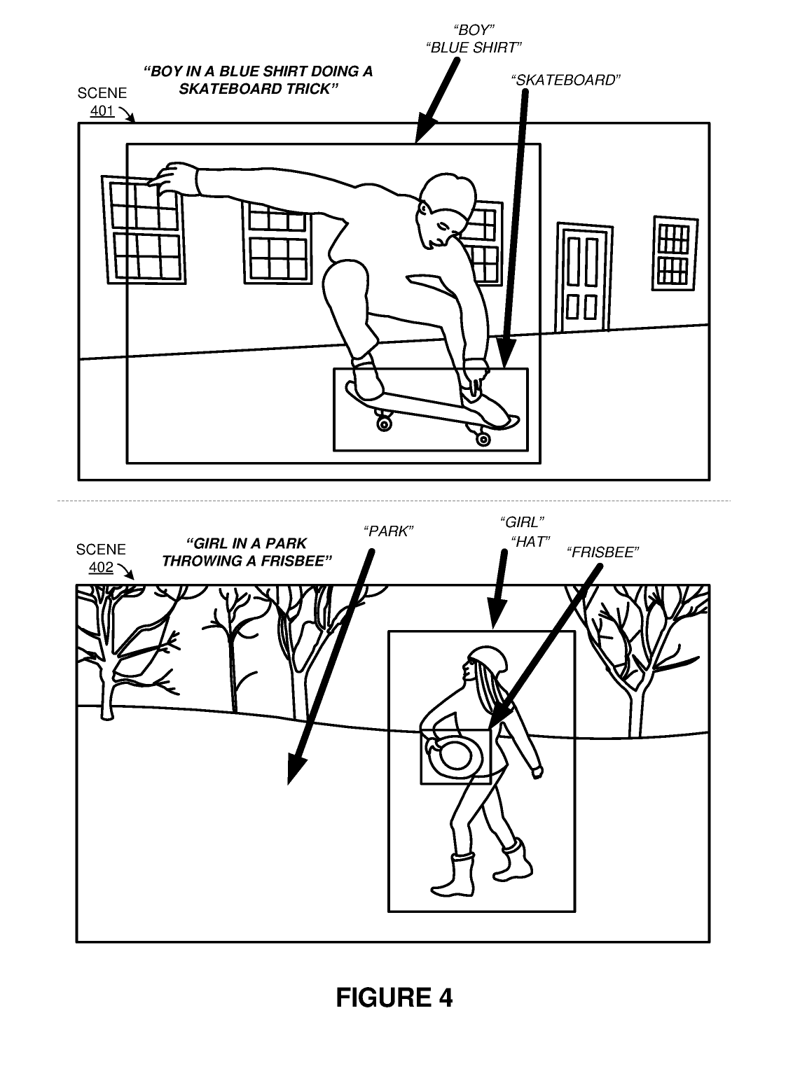

Further examples of image processing, assistance, and recognition are found below in FIGS. 4-7. Turning now to FIG. 4, in scene 401, a user captures an image on a user device of a street scene outdoors. The user can ask the user device to describe the scene. Responsively, the image can be transferred to one or more recognition services which interpret the scene and image data to present structured information about the scene. For example, scene 401 shows two main image zones, with a first zone recognizing a boy in a blue shirt and a second zone recognizing a skateboard. Image interpretation services can then describe the scene in words to the user, such as “a boy in a blue shirt doing a skateboard trick.”

In scene 402, another image is captured on a user device of an outdoor scene in a park. The user can ask the user device to describe the scene. Responsively, the image can be transferred to one or more recognition services which interpret the scene and image data to present structured information about the scene. Scene 402 shows two main image zones, with a first zone recognizing a girl in a hat and a second zone recognizing a frisbee. A general image recognition process can recognize that the scene is of a park. Image interpretation services can then describe the scene in words to the user, such as “a girl wearing a hat in a park throwing a frisbee.”

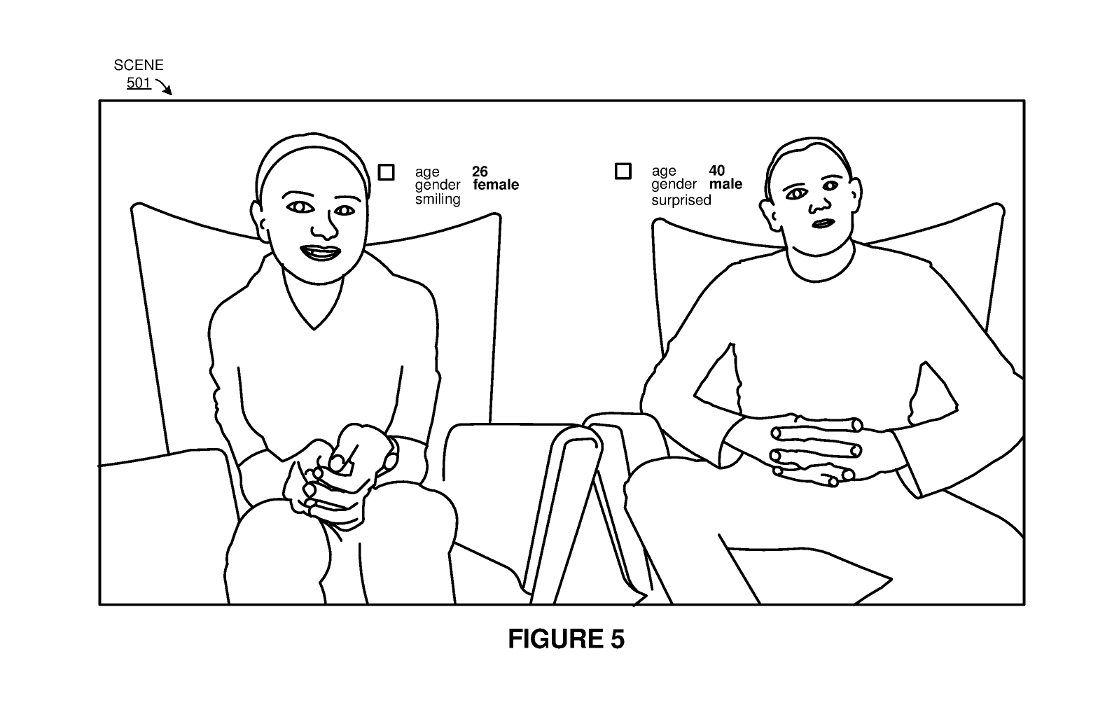

FIG. 5 illustrates another image recognition scenario. In this example scene 501, perhaps an office setting or meeting is occurring. The user might want to know if the meeting participants are present or paying attention. The user can capture an image of the scene and ask for a description of the people in the scene. Responsively, one or more services can be employed to determine that two people are seated in chairs in the scene. A first person's age, gender, and demeanor can be determined by processing the image and intelligently recognizing that the person is a girl, approximately age 26, and smiling A second person can be recognized as approximately age 40, male, and surprised.

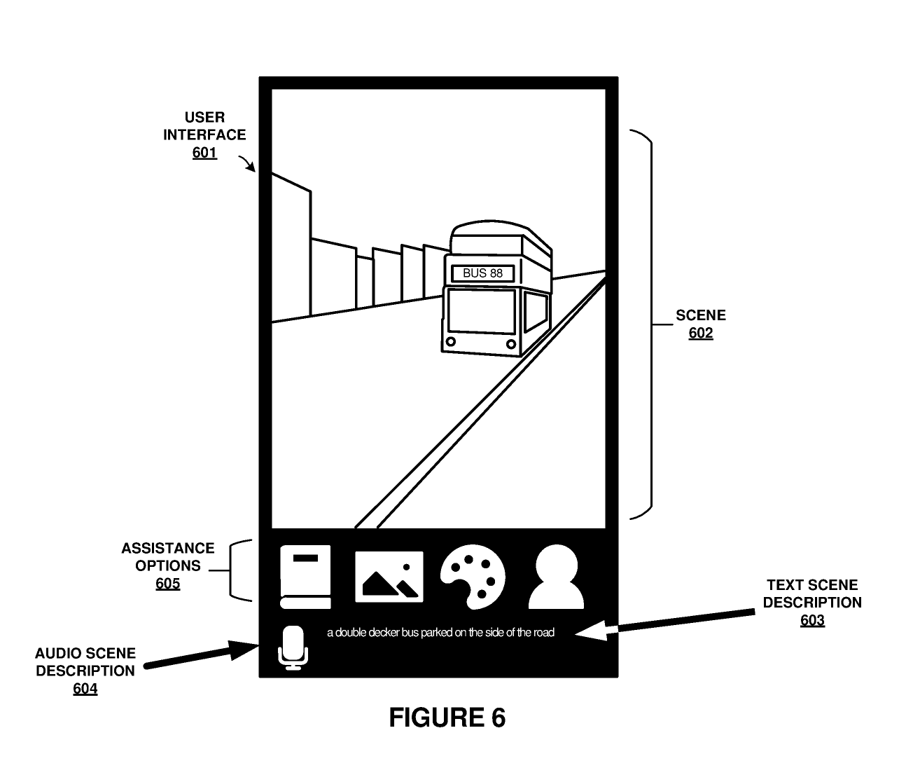

FIG. 6 illustrates another image recognition scenario of scene 602 presented on an example graphical user interface 601. User interface 601 can be presented on a user device, such as a smartphone, gaming device, laptop, or tablet computer, to allow a user to capture images and receive assistance with regards to captured images. Assistance option elements 605 are presented which give a user several options to select among for assistance. In this example, assistance option elements 605 include document recognition assistance indicated by the ‘book’ icon, image recognition assistance indicated by the ‘scene’ icon, color recognition assistance indicated by the ‘palette’ icon, and person/emotive recognition assistance indicated by the ‘person’ icon. Other options can be presented, and functionality of each option can vary than those described herein.

Furthermore, audio scene description element 604 and text scene description element 603 are included in user interface 601. Element 604 can be selected by a user to initiate an audio description of the scene. This audio description can be related over a speaker, headphones, or other audio device. Element 603 can provide a text-based description of the scene, and can be similar to that presented over audio using element 604. Thus, a user can initiate scene description using the elements of user interface 601.

In the example presented in FIG. 6, a user has captured an image of a street scene. The image can be processed by one or more recognition services responsive to the image capture, and information about the scene can be relayed to the user using elements 603 and 604. In scene 602, a street scene includes a bus. The scene can be described to the user as “a double decker bus on the side of the road.” The user might have follow-up questions or queries about the scene, and these can be provided to the one or more services which determine answers for the user. For example, the user might ask “what is the bus route number,” which is determined and relayed to the user as “route 88.” The user might then ask “tell me the schedule for route 88” or “what does the street sign say” and the one or more services can perform an information search on the bus schedule and route for route 88 along with descriptions of any imaged street signs. Further conversational questions and answers can arise from scene 602.

In addition to scene and object recognition, intelligent document recognition can be provided to a user. Examples of document recognition can include reading parts of a document based on the structure of the document. In a document example, a newspaper or magazine might be imaged by a user. The user can ask what the headlines are and inquire about various articles. In another example, a food menu might be imaged. This food menu might have structure comprising sections and headings which separate types of food (i.e. pasta, meat, fish) and courses of food (i.e. appetizers, entrees, desserts). The structure of menus, newspapers, or other documents can be used to intelligently convey information to the user by presenting headings first to a user, followed by information contained below a heading responsive to further questioning directed to that heading by a user.

For example, a user can capture an image of a menu in a restaurant. The user might ask, “read me the headings” which prompts the user device to provide the image to a recognition service along with the question. The recognition service can process the provided information to determine that the menu has several headings, such as based on font size, text placement relative to other text, prominence of text, etc. The user device can then read aloud the headings on the menu, which might prompt further questions. Such as “read me the salads” which can prompt the user device to recognize text under the “salad” heading and responsively read a listing of the salads. The user can then ask for further details on a particular salad, such as “what is the price of the cobb salad” or “are there nuts in the garden salad.”

In addition to assistance provided via scene recognition, assistance can be provided to users for the actual capture or taking of images. Audible guidance can be provided by a user device during capture of an image. The user might attempt to take a picture of a document, such as menu or sign, or to capture certain objects or elements in a scene. The user device can provide feedback and assistance in the capture process to ensure the object of interest is within the frame or scene captured by the user device. For example, a user might desire to capture an image of a food menu, and the user device can provide assistance to the user to center the menu in the image frame or to help the user align the menu in the frame.

In a first operational scenario, a user indicates that an image is to be captured of a document. The user device can identify the appropriate document in the frame, or a portion thereof. If the full document is not visible in the frame, the user device can provide guidance to the user to move the user device or associated imaging apparatus to bring the full document into the frame. The guidance comprises spoken or audible guidance, such as descriptive words or suggestive tones that direct a user to move an imaging apparatus to bring an object of interest fully into frame. For example, the guidance can include spoken instructions comprising “move camera to the bottom right and away from the document.”

In another scenario, guidance can be provided to a visually impaired user to capture a particular object or to adequately frame an image about some objects of interest. This guidance can include a constant stream of description to the user to audibly indicate what is currently being captured by the image. Once a scene or associated objects are adequately arranged in an image, then the user can capture the image and potentially share via social media, text messaging, or other sharing services. This process can enable a visually impaired person or even an automated imaging system to take effective photographs using a digital imaging device, such as a smartphone or tablet computing device.

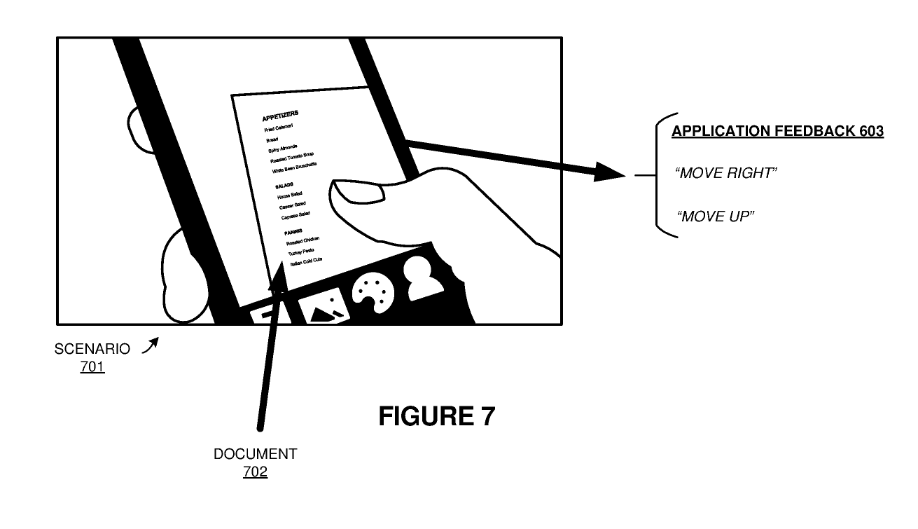

As s specific example, FIG. 7 illustrates scenario 701. FIG. 7 shows a smartphone device with an imaging user interface presented on the smartphone device. A similar interface as shown in FIG. 6 can be employed, although variations are possible. In FIG. 7, a user might initiate capture of an image and indicate that assistance is needed in the capture of the image. As seen in FIG. 7, document 702 is only partially in the frame of the image. An image capture assistance service can be employed to aid the user to move the smartphone so as to have the document fully in frame. The image can be provided to the image capture assistance service which then determines instructions for the user.

FIG. 7 includes example application feedback 603 to aid in capture of a document, such as a food menu or newspaper article. This feedback can be provided audibly to the user in a series of vocal instructions, such as “move right” or “move up,” among other instructions. This feedback can be provided as text instructions to the user on a screen of the smartphone. Once the document has been sufficiently established in the frame, then the user can be signaled to finalize capture of the image. Options for sharing and/or saving the image can then be presented to the user, textually or audibly, among other options.

To align and ensure documents or other objects are in frame and sufficiently aligned, various algorithms can be used. In a first example, edge detection can be performed on the image to establish boundaries for candidate objects as documents. Several candidate objects can be determined in an image, which can include candidate objects of various sizes and shapes. Optical character recognition can be performed on the image as well. Objects that contain text within their boundaries can be included in a list of candidate objects, and objects which do not contain text can be eliminated as candidate objects. Remaining document candidates can be ranked based on a hybrid score of (1) a number of pixels per character and (2) a number of edges under a threshold angle (i.e. documents typically have right angles to connect edges). The candidate object at the top of the list after ranking can be considered the currently tracked document and instructions for imaging assistance can be based on this document.

To guide a user to capture the full page or document in the frame, various techniques can be applied. For example, the document can be considered only partially in frame if associated edges or boundaries intersect the image boundaries. If none of the object/document boundaries intersect the image boundaries, then the full document can be considered as in frame and the user can be instructed to finalize the image or the user device can finalize capture of the image automatically.

If one or more edges or boundaries of the object intersects a boundary of the image, then that boundary can be used to direct the user to move the imaging apparatus. Instructions can be based on how many edges of the object intersect the boundaries of the image. For example, when only one object edge intersects the image boundary, then an instruction to the user might comprise “move up” or “move left” according to the direction needed to bring the object into frame. When more than one object edge intersects the image boundary, then an instruction might comprise a combination instruction, such as “move up and to the left” or “move to the bottom right and away from the document.” Moving closer and farther from the object can be instructed as well as directionality. This process can be repeated until no edges of the object/document of interest intersect or touch the boundaries of the image being captured. The full document can then be considered as in frame and the user can be instructed to finalize the image or the user device can finalize capture of the image automatically. Image rotation or object rotation can be performed on the image post-capture to rotate objects into a desired orientation.

FIG. 3 illustrates computing system 301 that is representative of any system or collection of systems in which the various operational architectures, scenarios, and processes disclosed herein may be implemented. For example, computing system 301 can be used to implement any of user device 110, assistance computing interface 140, or computing services 150 of FIG. 1.

Examples of user device 110 when implemented by computing system 301 include, but are not limited to, a smartphone, tablet computer, laptop, personal communication device, personal assistance device, wireless communication device, subscriber equipment, customer equipment, access terminal, telephone, mobile wireless telephone, personal digital assistant, personal computer, e-book, mobile Internet appliance, wireless network interface card, media player, game console, gaming system, or some other communication apparatus, including combinations thereof. Examples of assistance computing interface 140 or computing services 150 when implemented by computing system 301 include, but are not limited to, server computers, cloud computing systems, distributed computing systems, software-defined networking systems, computers, desktop computers, hybrid computers, rack servers, web servers, cloud computing platforms, and data center equipment, as well as any other type of physical or virtual server machine, and other computing systems and devices, as well as any variation or combination thereof.

Computing system 301 may be implemented as a single apparatus, system, or device or may be implemented in a distributed manner as multiple apparatuses, systems, or devices. Computing system 301 includes, but is not limited to, processing system 302, storage system 303, software 305, communication interface system 307, and user interface system 308. Processing system 302 is operatively coupled with storage system 303, communication interface system 307, and user interface system 308. When implementing a user device, computing system 301 can also include video and audio system 309.

Processing system 302 loads and executes software 305 from storage system 303. Software 305 includes assistance environment 306, which is representative of the processes, services, and platforms discussed with respect to the preceding Figures.

When executed by processing system 302 to provide imaging assistance services, document recognition services, or scene description services, among other services, software 305 directs processing system 302 to operate as described herein for at least the various processes, operational scenarios, and sequences discussed in the foregoing implementations. Computing system 301 may optionally include additional devices, features, or functionality not discussed for purposes of brevity.

Referring still to FIG. 3, processing system 302 may comprise a micro-processor and processing circuitry that retrieves and executes software 305 from storage system 303. Processing system 302 may be implemented within a single processing device, but may also be distributed across multiple processing devices or sub-systems that cooperate in executing program instructions. Examples of processing system 302 include general purpose central processing units, application specific processors, and logic devices, as well as any other type of processing device, combinations, or variations thereof.

Storage system 303 may comprise any computer readable storage media readable by processing system 302 and capable of storing software 305. Storage system 303 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 303 may also include computer readable communication media over which at least some of software 305 may be communicated internally or externally. Storage system 303 may be implemented as a single storage device, but may also be implemented across multiple storage devices or sub-systems co-located or distributed relative to each other. Storage system 303 may comprise additional elements, such as a controller, capable of communicating with processing system 302 or possibly other systems.

Software 305 may be implemented in program instructions and among other functions may, when executed by processing system 302, direct processing system 302 to operate as described with respect to the various operational scenarios, sequences, and processes illustrated herein. For example, software 305 may include program instructions for implementing imaging assistance services, document recognition services, or scene description services, among other services.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 305 may include additional processes, programs, or components, such as operating system software or other application software, in addition to or that include assistance environment 306. Software 305 may also comprise firmware or some other form of machine-readable processing instructions executable by processing system 302.

In general, software 305 may, when loaded into processing system 302 and executed, transform a suitable apparatus, system, or device (of which computing system 301 is representative) overall from a general-purpose computing system into a special-purpose computing system customized to provide imaging assistance services, document recognition services, or scene description services, among other assistance services. Indeed, encoding software 305 on storage system 303 may transform the physical structure of storage system 303. The specific transformation of the physical structure may depend on various factors in different implementations of this description. Examples of such factors may include, but are not limited to, the technology used to implement the storage media of storage system 303 and whether the computer-storage media are characterized as primary or secondary storage, as well as other factors.

For example, if the computer readable storage media are implemented as semiconductor-based memory, software 305 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Assistance environment 306 includes one or more software elements, such as OS 321 and applications 322. Applications 322 can include photo guidance service 323, document assistance service 324, scene description service 325, or other services which can provide assistance to a user. These services can employ one or more platforms or services deployed over a distributed computing system, such as services 350 in FIG. 3 that are interfaced via distributing computing interface 340. Applications 322 can receive user input through user interface system 308 or video and audio system 309. This user input can include user commands, user questions, as well as imaging data, scene data, audio data, or other input, including combinations thereof. Applications 322 can provide user assistance to a user by way of elements of user interface system 308 or communication system 307. Additionally, applications 322 can provide an interface to external elements, such as those shown for distributed computing interface 340 and services 350. Computing system 301 can provide captured perception data (i.e. images, video, audio, other sensor or location information) to external systems for processing and assistance rendering. Interpretation data and assistance data can be received into computing system 301 and presented to a user. API 326 can comprise one or more software defined interface elements for communicating logically with distributed computing interface 340 and elements of services 350.

Communication interface system 307 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. Physical or logical elements of communication interface system 307 can receive link/quality metrics, and provide link/quality alerts or dashboard outputs to users or other operators.

User interface system 308 may include a keyboard, a mouse, a voice input device, a touch input device for receiving input from a user. Output devices such as a display, speakers, web interfaces, terminal interfaces, and other types of output devices may also be included in user interface system 308. User interface system 308 can provide output and receive input over a network interface, such as communication interface system 307. In network examples, user interface system 308 might packetize display or graphics data for remote display by a display system or computing system coupled over one or more network interfaces. Physical or logical elements of user interface system 308 can provide link/quality alerts or dashboard outputs to users or other operators. User interface system 308 may also include associated user interface software executable by processing system 302 in support of the various user input and output devices discussed above. Separately or in conjunction with each other and other hardware and software elements, the user interface software and user interface devices may support a graphical user interface, a natural user interface, or any other type of user interface.

Video and audio system 309 comprises various hardware and software elements for capturing digital images, video data, audio data, or other sensor data which can be used to render assistance to users of computing system 301. Video and audio system 309 can include digital imaging elements, digital camera equipment and circuitry, microphones, light metering equipment, illumination elements, or other equipment and circuitry. Analog to digital conversion equipment, filtering circuitry, image or audio processing elements, or other equipment can be included in video and audio system 309.

Communication between computing system 301 and other computing systems (not shown), may occur over a communication network or networks and in accordance with various communication protocols, combinations of protocols, or variations thereof. For example, computing system 301 when implementing a user device, might communicate with distributed computing interface 340. Examples networks include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transmission control protocol (TCP), and the user datagram protocol (UDP), as well as any other suitable communication protocol, variation, or combination thereof.

Certain inventive aspects may be appreciated from the foregoing disclosure, of which the following are various examples.

### EXAMPLE 1

An assistance application provided for a user interface device, comprising an imaging system configured capture an image of a scene, an assistance interface configured to provide data associated with the image to a distributed assistance service that responsively processes the data to recognize properties of the scene and establish feedback for a user based at least on the properties of the scene, and a user interface configured to provide the feedback to the user.

### EXAMPLE 2

The assistance application of Example 1, comprising the assistance interface configured to indicate to the distributed assistance service a scene recognition request for the data associated with the image, and responsively receive at least partial recognition information for at least one element in the scene.

### EXAMPLE 3

The assistance application of Examples 1-2, where the partial recognition information comprises graphical annotations related to descriptions of objects in the scene, and comprising the assistance interface configured to merge the graphical annotations with the scene, and the user interface configured to present the graphical annotations overlaid with the scene to the user.

### EXAMPLE 4

The assistance application of Examples 1-3, comprising the assistance interface configured to receive repositioning instructions determined by the distributed assistance service to increase a recognition level of at least one element in the scene, and the user interface configured to present the repositioning instructions to the user.

### EXAMPLE 5

The assistance application of Examples 1-4, where the repositioning instructions comprise directional notifications which prompt the user to move an imaging sensor of the imaging system to increase the recognition level of the at least one element in the scene.

### EXAMPLE 6

The assistance application of Examples 1-5, comprising the user interface configured to indicate to the user an alert to capture an image based on a state of the repositioning instructions.

### 7

The assistance application of Examples 1-6, comprising the assistance interface configured to indicate to the distributed assistance service a scene recognition request for the data associated with the image, and responsively receive a description of the scene, and the user interface configured to present the description of the scene to the user.

### EXAMPLE 8

The assistance application of Examples 1-7, comprising the user interface configured to receive one or more queries from the user related to the description of the scene, the assistance interface configured to indicate to the distributed assistance service further scene recognition requests related to the one or more queries related to the description of the scene and responsively receive one or more further descriptions of the scene, and the user interface configured to present the one or more further descriptions of the scene to the user.

### EXAMPLE 9

The assistance application of Examples 1-8, comprising the assistance interface configured to indicate a document recognition request with the data associated with the image to the distributed assistance service, where the distributed assistance service responsively recognizes one or more textual formatting properties of a document captured in the image, the assistance interface configured to receive document description information determined based at least on the one or more textual formatting properties of a document captured in the image, and the user interface configured to present the document description information to the user.

### EXAMPLE 10

An apparatus comprising one or more computer readable storage media and program instructions stored on the one or more computer readable storage media. When executed by a processing system, the program instructions direct the processing system to at least receive an image of a scene captured by an imaging element, provide data associated with the image to a remote assistance interface that responsively selects one or more distributed recognition services to recognize properties of the scene and establish feedback for a user based at least on the properties of the scene, and provide the feedback to the user via a user interface.

### EXAMPLE 11

The apparatus of Example 10, comprising further program instructions, when executed by the processing system, direct the processing system to at least indicate to the remote assistance interface a scene recognition request for the data associated with the image, and responsively receive at least partial recognition information for at least one element in the scene.

### EXAMPLE 12

The apparatus of Examples 10-11, comprising further program instructions, when executed by the processing system, direct the processing system to at least receive a query from the user related to the at least one element in the scene, indicate the query to the remote assistance interface that responsively selects among the one or more distributed recognition services to provide further recognition information, and present the further recognition information to the user.

### EXAMPLE 13

The apparatus of Examples 10-12, comprising further program instructions, when executed by the processing system, direct the processing system to at least receive repositioning instructions determined by the one or more distributed recognition services to increase a recognition level of at least one element in the scene, and present the repositioning instructions to the user.

### EXAMPLE 14

The assistance application of Examples 10-13, where the repositioning instructions comprise directional notifications which prompt the user to move the imaging element to increase the recognition level of the at least one element in the scene.

### EXAMPLE 15

The apparatus of Examples 10-14, comprising further program instructions, when executed by the processing system, direct the processing system to at least indicate to the user an alert to capture an image based on a state of the repositioning instructions.

### EXAMPLE 16

The apparatus of Examples 10-15, comprising further program instructions, when executed by the processing system, direct the processing system to at least indicate to the remote assistance interface a scene recognition request for the data associated with the image, and responsively receive a description of the scene, and present the description of the scene to the user.

### EXAMPLE 17

The apparatus of Examples 10-16, comprising further program instructions, when executed by the processing system, direct the processing system to at least receive one or more queries from the user related to the description of the scene, indicate to the remote assistance interface further scene recognition requests for the one or more queries related to the description of the scene and responsively receive one or more further descriptions of the scene, and present the one or more further descriptions of the scene to the user.

### EXAMPLE 18

The apparatus of Examples 10-17, comprising further program instructions, when executed by the processing system, direct the processing system to at least indicate a document recognition request with the data associated with the image to the remote assistance interface, where the remote assistance interface responsively selects at least a document recognition service among the one or more distributed recognition services to recognize one or more textual formatting properties of a document captured in the image, receive document description information determined based at least on the one or more textual formatting properties of a document captured in the image, and present the document description information to the user.

### EXAMPLE 19

The apparatus of Examples 10-18, comprising further program instructions, when executed by the processing system, direct the processing system to at least, based on the document description information, perform at least one search query using descriptors in the document description information to retrieve further descriptors for the document, and present the further descriptors to the user.

### EXAMPLE 20

A user interface device, comprising an imaging apparatus configured capture one or more images of a scene, an assistance application configured to provide data associated with the one or more images to an assistance computing interface that responsively selects one or more distributed recognition services to recognize properties of the scene to establish graphical annotations related to the scene based at least on the properties of the scene, and a network interface configured to communicate with the assistance computing interface.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. An assistance application provided for a user interface device, comprising:
an imaging system configured capture an image of a scene;
an assistance interface configured to provide data associated with the image to a distributed assistance service that responsively processes the data to recognize properties of the scene and establish feedback for a user based at least on the properties of the scene;
a user interface configured to provide the feedback to the user.

2. The assistance application of claim 1, comprising:
the assistance interface configured to indicate to the distributed assistance service a scene recognition request for the data associated with the image, and responsively receive at least partial recognition information for at least one element in the scene.

3. The assistance application of claim 2, wherein the partial recognition information comprises graphical annotations related to descriptions of objects in the scene, and comprising:
the assistance interface configured to merge the graphical annotations with the scene;
the user interface configured to present the graphical annotations overlaid with the scene to the user.

4. The assistance application of claim 1, comprising:
the assistance interface configured to receive repositioning instructions determined by the distributed assistance service to increase a recognition level of at least one element in the scene;
the user interface configured to present the repositioning instructions to the user.

5. The assistance application of claim 4, wherein the repositioning instructions comprise directional notifications which prompt the user to move an imaging sensor of the imaging system to increase the recognition level of the at least one element in the scene.

6. The assistance application of claim 4, comprising:
the user interface configured to indicate to the user an alert to capture an image based on a state of the repositioning instructions.

7. The assistance application of claim 1, comprising:
the assistance interface configured to indicate to the distributed assistance service a scene recognition request for the data associated with the image, and responsively receive a description of the scene; and
the user interface configured to present the description of the scene to the user.

8. The assistance application of claim 7, comprising:
the user interface configured to receive one or more queries from the user related to the description of the scene;
the assistance interface configured to indicate to the distributed assistance service further scene recognition requests related to the one or more queries related to the description of the scene and responsively receive one or more further descriptions of the scene; and
the user interface configured to present the one or more further descriptions of the scene to the user.

9. The assistance application of claim 1, comprising:
the assistance interface configured to indicate a document recognition request with the data associated with the image to the distributed assistance service, wherein the distributed assistance service responsively recognizes one or more textual formatting properties of a document captured in the image;
the assistance interface configured to receive document description information determined based at least on the one or more textual formatting properties of a document captured in the image; and
the user interface configured to present the document description information to the user.

10. An apparatus comprising:
one or more computer readable storage media;
program instructions stored on the one or more computer readable storage media that, when executed by a processing system, direct the processing system to at least:
receive an image of a scene captured by an imaging element;
provide data associated with the image to a remote assistance interface that responsively selects one or more distributed recognition services to recognize properties of the scene and establish feedback for a user based at least on the properties of the scene;
provide the feedback to the user via a user interface.

11. The apparatus of claim 10, comprising further program instructions, when executed by the processing system, direct the processing system to at least:
indicate to the remote assistance interface a scene recognition request for the data associated with the image, and responsively receive at least partial recognition information for at least one element in the scene.

12. The apparatus of claim 11, comprising further program instructions, when executed by the processing system, direct the processing system to at least:
receive a query from the user related to the at least one element in the scene;
indicate the query to the remote assistance interface that responsively selects among the one or more distributed recognition services to provide further recognition information;
present the further recognition information to the user.

13. The apparatus of claim 10, comprising further program instructions, when executed by the processing system, direct the processing system to at least:
receive repositioning instructions determined by the one or more distributed recognition services to increase a recognition level of at least one element in the scene;
present the repositioning instructions to the user.

14. The apparatus of claim 13, wherein the repositioning instructions comprise directional notifications which prompt the user to move the imaging element to increase the recognition level of the at least one element in the scene.

15. The apparatus of claim 13, comprising further program instructions, when executed by the processing system, direct the processing system to at least:
indicate to the user an alert to capture an image based on a state of the repositioning instructions.

16. The apparatus of claim 10, comprising further program instructions, when executed by the processing system, direct the processing system to at least:
indicate to the remote assistance interface a scene recognition request for the data associated with the image, and responsively receive a description of the scene; and
present the description of the scene to the user.

17. The apparatus of claim 16, comprising further program instructions, when executed by the processing system, direct the processing system to at least:
receive one or more queries from the user related to the description of the scene;
indicate to the remote assistance interface further scene recognition requests for the one or more queries related to the description of the scene and responsively receive one or more further descriptions of the scene; and
present the one or more further descriptions of the scene to the user.

18. The apparatus of claim 10, comprising further program instructions, when executed by the processing system, direct the processing system to at least:
indicate a document recognition request with the data associated with the image to the remote assistance interface, wherein the remote assistance interface responsively selects at least a document recognition service among the one or more distributed recognition services to recognize one or more textual formatting properties of a document captured in the image;
receive document description information determined based at least on the one or more textual formatting properties of a document captured in the image; and
present the document description information to the user.

19. The apparatus of claim 18, comprising further program instructions, when executed by the processing system, direct the processing system to at least:
based on the document description information, perform at least one search query using descriptors in the document description information to retrieve further descriptors for the document; and
present the further descriptors to the user.

20. A user interface device, comprising:
an imaging apparatus configured capture one or more images of a scene;
an assistance application configured to provide data associated with the one or more images to an assistance computing interface that responsively selects one or more distributed recognition services to recognize properties of the scene to establish graphical annotations related to the scene based at least on the properties of the scene; and
a network interface configured to communicate with the assistance computing interface.
